(19) United States
(12) Patent Application Publication
(10) Pub. No.: US 2020/0246986 A1
(43) Pub. Date: Aug. 6, 2020

(54) MULTIFUNCTIONAL CUTTER

(71) Applicant: Hong Ann Tool Industries Co., Ltd., Taichung City (TW)

(72) Inventor: Cheng-Wei SU, Taichung City (TW)

(21) Appl. No.: 16/665,247

(22) Filed: Oct. 28, 2019

(30) Foreign Application Priority Data
Feb. 1, 2019 (TW) 108104318

(51) Int. Cl. B26B 9/02; B26B 3/00

(52) U.S. Cl. CPC B26B 9/02; B26B 3/00

(57) ABSTRACT

A multifunctional cutter includes a body and a blade received by the body. The body has an end surface. The end surface extends on a reference plane. The blade has a cutting edge including a first cutting edge portion and a second cutting edge portion. The blade in a use position includes the first and the second cutting edge portions disposed outside of the body. The first cutting edge portion extends arcuately and is concave. The second cutting edge portion extends linearly and is straight. The first cutting edge portion has an end point adjacent to the second cutting edge portion. A tangent line to first the cutting edge portion at the end point intersects with the reference plane. The tangent line and the reference plane defines a first included angle which is less than 90 degrees.

### BACKGROUND OF THE INVENTION

### 1. Field of the Invention

The present invention relates to a multifunctional cutter.

### 2. Description of the Related Art

TW Pat. No. M415789 shows a strap knife. The strap knife includes a first cutter at a first end for cutting a packaging tape and a second cutter at a second end for cutting a packaging strap. The strap knife also includes a two guiding slopes adjacent to the second cutter. The two guiding slopes have a common end and divergent along a longitudinal direction of the strap knife. The strap knife can save a user the troublesome to use one knife for cutting a packaging tape and another knife for cutting a strap. It is, however, inconvenient for the user to operate two cutters.

The present invention is, therefore, intended to obviate or at least alleviate the problems encountered in the prior art.

### SUMMARY OF THE INVENTION

According to the present invention, a multifunctional cutter includes a body. The body has an end surface. The end surface extends on a reference plane. The multifunctional cutter also includes a blade received by the body. The blade has a cutting edge including a first cutting edge portion and a second cutting edge portion. The blade in a use position includes the first and the second cutting edge portions disposed outside of the body. The first cutting edge portion extends arcuately and is concave. The second cutting edge portion extends linearly and is straight. The first cutting edge portion has an end point adjacent to the second cutting edge portion. A tangent line to the first cutting edge portion at the end point intersects with the reference plane. The tangent line and the reference plane defines a first included angle which is less than 90 degrees.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a multifunctional cutter in accordance with the present invention.

FIG. 2 is a side view of the multifunctional cutter of FIG. 1.

FIG. 3 is a side view illustrating cutting a strap with a first portion of a blade of the multifunctional cutter of FIG. 1, with the cutting direction indicated by an arrow.

FIG. 4 is a side view illustrating cutting a tape with a second portion of the blade of the multifunctional cutter of FIG. 1, with the cutting direction indicated by an arrow.

### DETAILED DESCRIPTION OF THE INVENTION

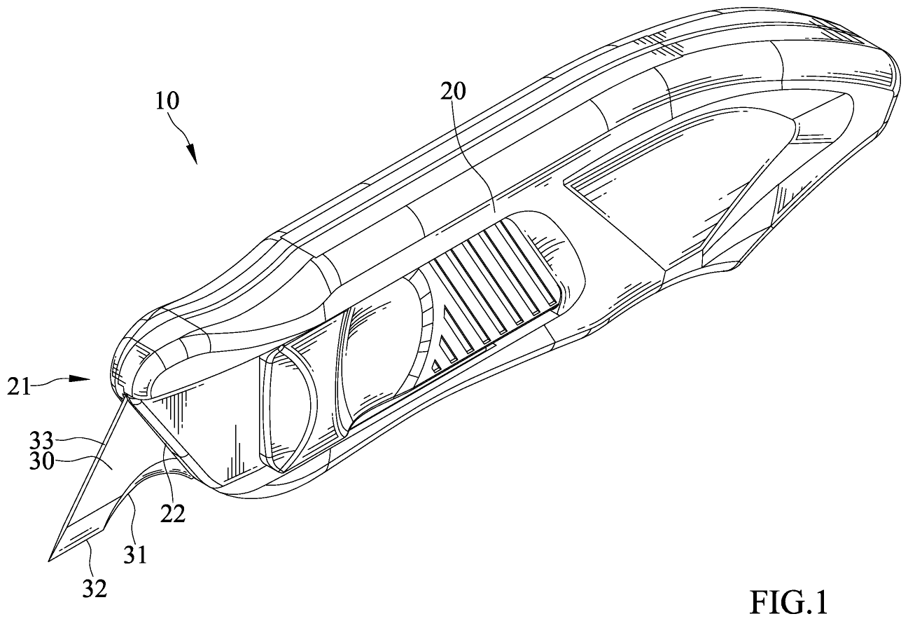

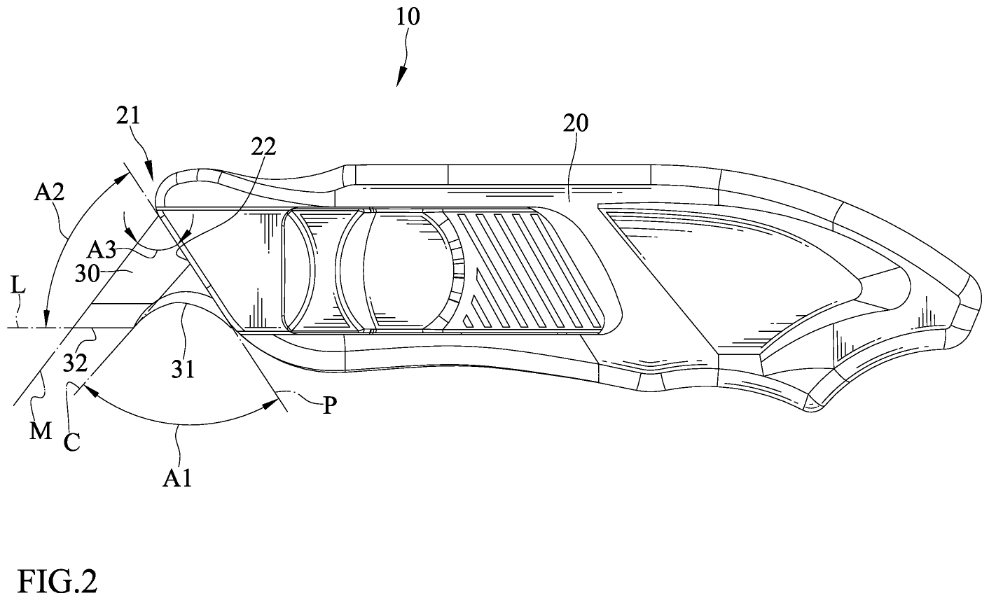

FIGS. 1 through 4 show a multifunctional cutter 10 in accordance with the present invention.

The multifunctional cutter 10 includes a body 20. The body 20 can be used as a handle when using the multifunctional cutter 10. The body 20 has an end surface 22. The end surface 22 extends on a reference plane P. The end surface 22 is at a front end 21 of the main body 20.

The multifunctional cutter 10 includes a blade 30 received by the body 20. The blade 30 has a cutting edge including a cutting edge portion 31 and a cutting edge portion 32. The cutting edge portion 31 extends arcuately and is concave. The cutting edge portion 32 extends linearly and is straight. The cutting edge of the blade 30 includes the cutting edge portion 31 of a first length and the cutting edge portion 32 of a second length respectively. The first length is greater than the second length. The cutting edge portion 31 is adjoined to the cutting edge portion 32. The cutting edge portion 32 has an end defining a tip of the blade 30. The cutting edge portion 31 has an end point adjacent to the cutting edge portion 32. A tangent line C to the cutting edge portion 31 at the end point intersects with the reference plane P. The tangent line C and the reference plane P defines an included angle A1, which is less than 90 degrees. Preferably, the angle A1 is greater than 55 degrees and less than 85 degrees. Preferably, the included angle A1 is 75 degrees. The cutting edge portion 32 extends on a reference line L. The reference line L intersects with the reference plane P. The reference line L and the reference plane P define an included angle A2 which is less than 90 degrees. Preferably, the included angle A2 is greater than 40 degrees and less than 75 degrees. Preferably, the included angle A2 is 57 degrees.

The blade 30 in a use position includes the cutting edge portions 31 and 32 disposed outside of the body 20.

The blade 30 has a back 33. The blade 30 in the use position includes the back 33 disposed outside of the body 20. The back 33 is inclined to the cutting edge portion 32.

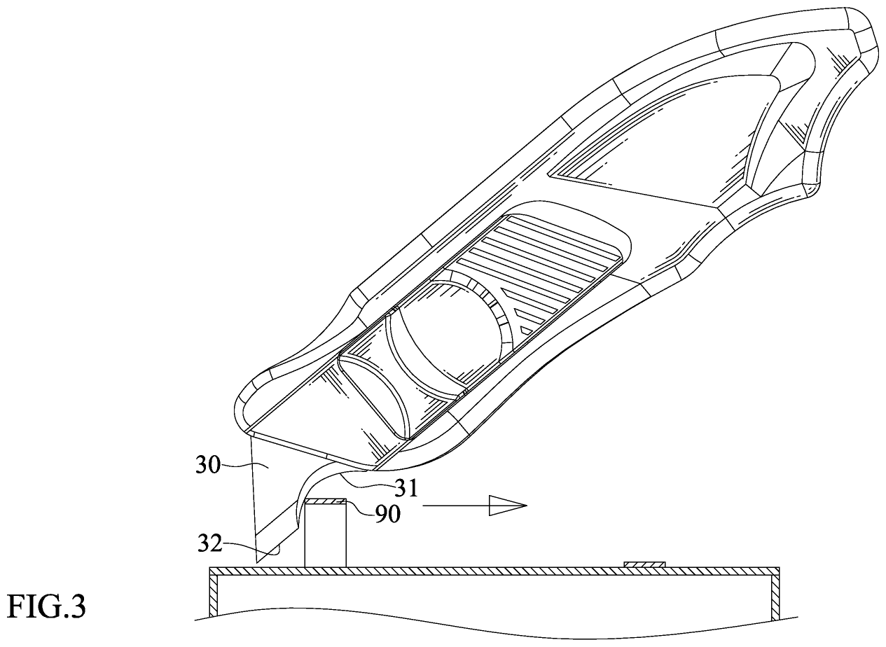

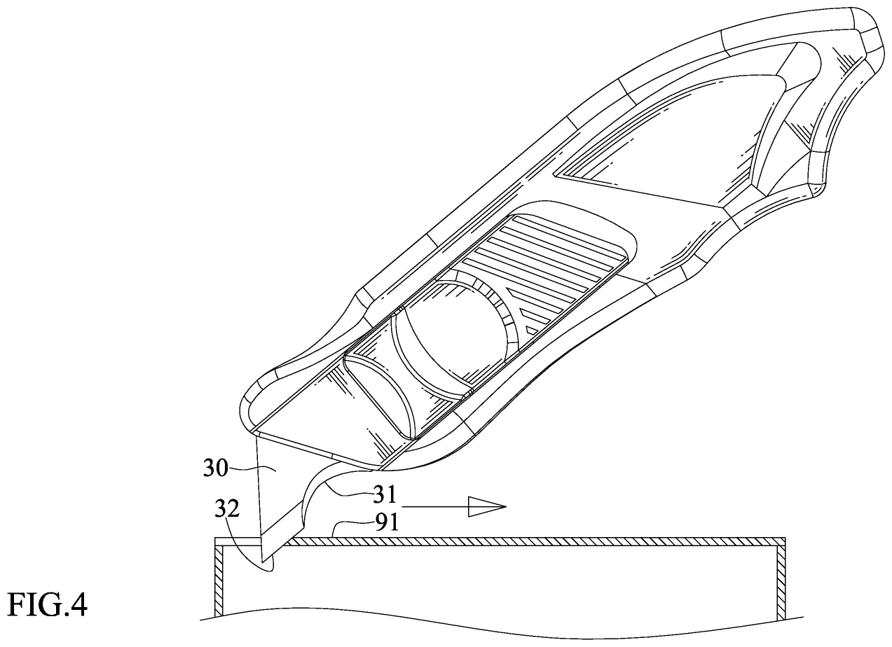

The back 33 extends on a reference line M. The reference line M intersects with the reference plane P. The first reference line M and the reference plane P define an included angle A3 not greater than 90 degrees. FIG. 3 shows cutting a strap 90 with the cutting edge portion 31. FIG. 4 shows inserting the tip of the blade 30 through a tape 91 and then cutting the tape 91 with the cutting edge portion 32.

In view of the foregoing, the strap 90 can be cut with the cutting edge portion 31 of the blade 30, and the tape 91 can be cut with the cutting edge portion 32 of the blade 30. Therefore, the blade 30 of the multifunctional cutter 10 eases the user's burden to cut the strap 90 and the tape 91 as described in the Description of the Related Art.

The foregoing is merely illustrative of the principles of this invention and various modifications can be made by those skilled in the art without departing from the scope and spirit of the invention.

What is claimed is:

1. A multifunctional cutter comprising:
a body, wherein the body has an end surface, and wherein the end surface extends on a reference plane; and
a blade received by the body, wherein the blade has a cutting edge including a first cutting edge portion and a second cutting edge portion, wherein the blade in a use position includes the first and the second cutting edge portions disposed outside of the body, wherein the first cutting edge portion extends arcuately and is concave, wherein the second cutting edge portion extends linearly and is straight, wherein the first cutting edge portion has an end point adjacent to the second cutting edge portion, a tangent line to the cutting edge portion at the end point intersects with the reference plane, and the tangent line and the reference plane defines a first included angle which is less than 90 degrees.

2. The multifunctional cutter as claimed in claim 1, wherein the second cutting edge portion extends on a first reference line, and wherein the first reference line intersects with the reference plane, and the first reference line and the reference plane define a second included angle which is less than 90 degrees.

3. The multifunctional cutter as claimed in claim 1, wherein first included angle is greater than 55 degrees and less than 85 degrees.

4. The multifunctional cutter as claimed in claim 2, wherein first included angle is greater than 55 degrees and less than 85 degrees, and wherein the second included angle is greater than 40 degrees and less than 75 degrees.

5. The multifunctional cutter as claimed in claim 3, wherein the first included angle is 75 degrees.

6. The multifunctional cutter as claimed in claim 4, wherein the first included angle is 75 degrees, and wherein the second included angle is 57 degrees.

7. The multifunctional cutter as claimed in claim 1, wherein the first cutting edge portion is adjoined to the second cutting edge portion.

8. The multifunctional cutter as claimed in claim 1, wherein the blade has a back, wherein the blade in the use position includes the back disposed outside of the body, and wherein the back is inclined to the second cutting edge portion.

9. The multifunctional cutter as claimed in claim 8, wherein the back extends on a second reference line, and wherein the second reference line intersects with the reference plane, and the first reference line and the reference plane define a third included angle not greater than 90 degrees.

10. The multifunctional cutter as claimed in claim 1, wherein the second cutting edge portion has an end defining a tip of the blade.

11. The multifunctional cutter as claimed in claim 1, wherein the cutting edge of the blade includes the first cutting edge portion of a first length and the second cutting edge portion of a second length respectively, and wherein the first length is greater than the second length.
